(19) United States
(12) Patent Application Publication
(10) Pub. No.: US 2008/0152229 A1
(43) Pub. Date: Jun. 26, 2008

(54) Monitoring device and monitoring method

(75) Inventors: Wei-Han Wang, Taipei (TW); Yu-Lun Ho, Taipei (TW); Ya-Hui Tsai, Taoyuan (TW); Ching-Yi Liu, Hsinchu (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/714,781

(22) Filed: Mar. 7, 2007

(30) Foreign Application Priority Data
Dec. 26, 2006 (TW) 95149024

(51) Int. Cl. G06K 9/66

(52) U.S. Cl. 382/192

(57) ABSTRACT

A monitoring device and a monitoring method are provided. The monitoring device includes an image-capturing unit, an image-determining unit and a mark-catapulting unit. The image-capturing device is used for capturing an image of a person. The image-determining unit is used for determining whether the image of the person is an image of an invader. The mark-catapulting unit is used for catapulting a mark to the invader.

This application claims the benefit of Taiwan application Serial No. 095149024, filed Dec. 26, 2006, the subject matter of which is incorporated herein by reference.

### BACKGROUND OF THE INVENTION

1. Field of the Invention

The invention relates in general to a monitoring device and monitoring method, and more particularly to an active monitoring device and monitoring method.

2. Description of the Related Art

As people expect a higher security standard of their living and office environment, many residential houses and public places alike are installed with monitoring device. Conventional monitoring device captures an image and then stores the image in a film or hard disk. The recorded image can be provided to the police to collect the evidence and track the invader.

However, if the invader pre-meditates to commit a crime, the invader would normally wear a mask or a headgear lest the image might be taken as a piece of evidence. In the case of an unplanned offence, it is very difficult to track the offenders if the offenders hide themselves in the crowd.

Thus, how to enhance the efficiency of the monitoring device and increase the crime-cracking rate is indeed an important direction to be taken.

### SUMMARY OF THE INVENTION

The invention is directed to a monitoring device and a monitoring method. In addition to determining whether a person is an invader, the monitoring device and the monitoring method further catapults a mark to the invader by the mark-catapulting unit, not only scaring the invader but also leaving an obvious and hard-to-remove mark on the invader. The police and people can easily recognize the invader according to the mark, making crime cracking easier.

According to a first aspect of the present invention, a monitoring device is provided. The monitoring device includes an image-capturing unit, an image-determining unit and a mark-catapulting unit. The image-capturing unit is for capturing an image of a person. The image-determining unit is used for determining whether the image of the person is an image of an invader. The mark-catapulting unit is used for catapulting a mark to the invader.

According to a second aspect of the present invention, a monitoring method is provided. The monitoring method includes the following steps. An image of a person is captured. Whether the image of the person is an image of an invader is determined. If the person is an invader, then a mark is catapulted to the invader.

The invention will become apparent from the following detailed description of the preferred but non-limiting embodiments. The following description is made with reference to the accompanying drawings.

### BRIEF DESCRIPTION OF THE DRAWINGS

FIG. 1 is a functional block diagram of a monitoring device according to a first embodiment of the invention;

FIG. 2 is a flowchart of a monitoring method according to a first embodiment of the invention;

FIG. 3 is a perspective of a frame captured by an image-capturing unit;

FIG. 4 is a functional block diagram of a monitoring device according to a second embodiment of the invention; and

FIG. 5 is a flowchart of a monitoring method according to a second embodiment of the invention.

### DETAILED DESCRIPTION OF THE INVENTION

### First Embodiment

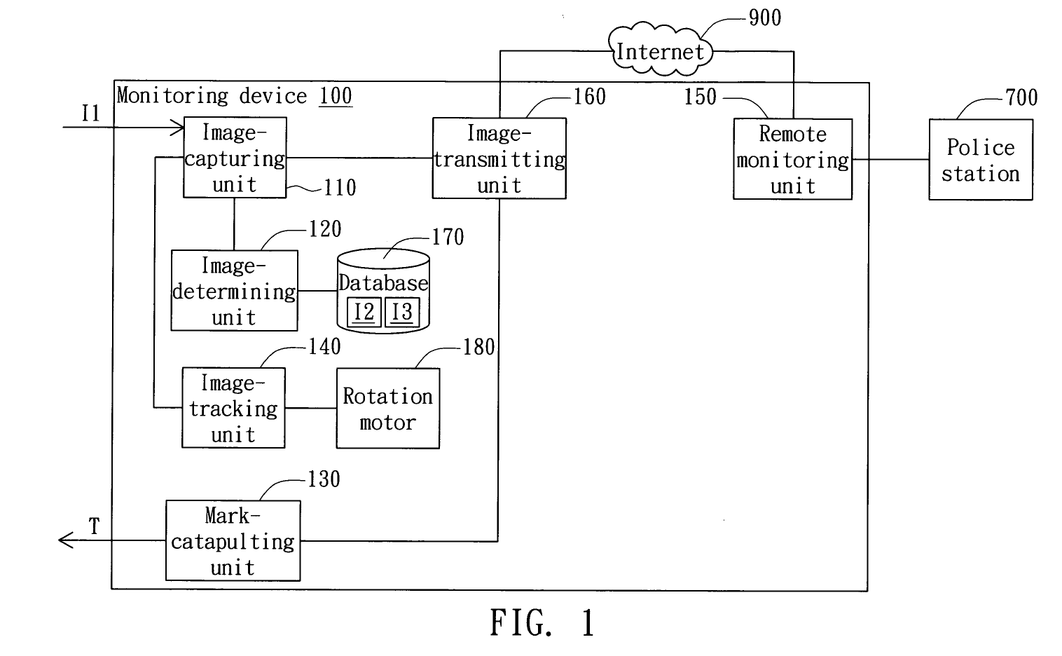

Referring to FIG. 1, a functional block diagram of a monitoring device 100 according to a first embodiment of the invention is shown. The monitoring device 100 at least includes an image-capturing unit 110, an image-determining unit 120 and a mark-catapulting unit 130. The image-capturing unit 110 is for capturing an image of a person I1. The image-determining unit 120 is used for determining whether the image of the person I1 is an image of an invader by comparison. If the person is identified as an invader, then the mark-catapulting unit 130 catapults a mark T to the invader. Examples of the mark T include paint, a paint capsule, powder, a powder capsule or a mini signal transmitter. Catapulting a mark to the invader by the mark-catapulting unit 130 functions to scare the invader and further leave an obvious and hard-to-remove mark on the invader. The police and people can easily recognize the invader according to the mark, making crime cracking easier.

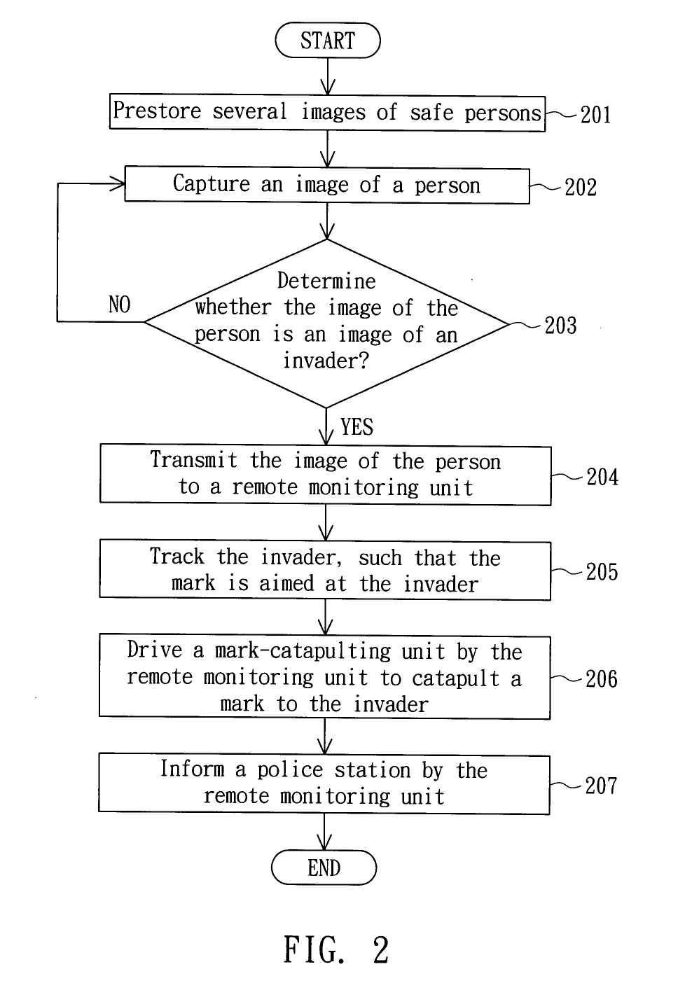

The monitoring method of the invention is elaborated by an accompanying flowchart. Referring to both FIG. 1 and FIG. 2. FIG. 2 is a flowchart of a monitoring method according to a first embodiment of the invention. However, the monitoring method of the invention is not limited thereto.

Firstly, the method begins at step 201, a plurality of safe persons' image I2 and a head coverage image 13 are stored in advance. As indicated in FIG. 1, the monitoring device 100 further includes a database 170. The safe persons' images I2 and head coverage image I3 are stored in the database 170.

Next, the method proceeds to step 202, an image of a person 11 is captured.

Then, the method proceeds to step 203, whether the image of the person I1 is the image of an invader is determined by comparison.

When the monitoring device 100 is installed at home, and the image of the person I1 is received from the image-capturing unit 110 by the image-determining unit 140, the image-determining unit 140 starts to determine whether the image of the person I1 is different from the safe persons' images I2 by comparison. If so, the person is identified as an invader; otherwise, the method returns to step 202, the image of the person I1 is captured again.

When the monitoring device 100 is installed at a public place, and the image of the person I1 is received from the image-capturing unit 110 by the image-determining unit 140, the image-determining unit 140 starts to determine whether the person's head image I1 has the head-covered image I3 by comparison. If so, the person is identified as an invader; otherwise, the method return to step 202, the image of the person I1 is captured again.

Next, the method proceeds to step 204, the image of the person I1 is transmitted to a remote monitoring unit 150. As indicated in FIG. 1, the monitoring device 100 further includes the remote monitoring unit 150 and an image-transmitting unit 160. The remote monitoring unit 150 is disposed at a remote end. The image-transmitting unit 160 receives the image of the person I1 from the image-capturing unit 100 and then transmits the image of the person I1 to the remote monitoring unit 150.

The image-transmitting unit 160 and the remote monitoring unit 150 can be connected by a cable directly or exchange data with each other via an Internet 900 or wireless waves. In the present embodiment of the invention, the image transmitting unit 160 and the remote monitoring unit 150 exchange data with each other via the Internet 900.

Then, the method proceeds to step 205, the invader is tracked such that the image-capturing unit 110 and mark Tare aimed at the invader. As indicated in FIG. 1, the monitoring device 100 further includes an image-tracking unit 140 and a rotation motor 180. The image-tracking unit 140 is for tracking the invader, such that the image-capturing unit 110 and mark T are aimed at the invader.

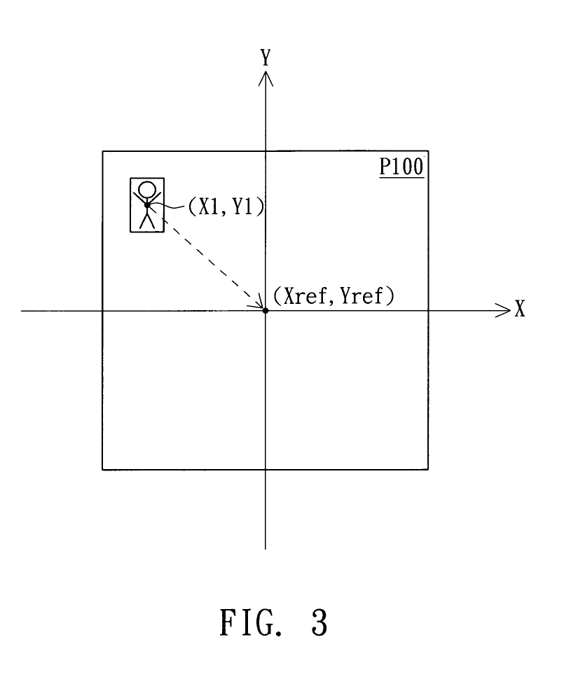

Referring to FIG. 3, a perspective of a frame P100 captured by an image-capturing unit 110 is shown. The image-tracking unit 140 receives several continuous frames P100 from the image-capturing unit 110, wherein the frame P100 has a dynamic change area, which is exactly the image of the person I1. Through the frame P100 and dynamic change area, the image-tracking unit 140 obtains the coordinates (X1, X2) of the frame P100 at which the image of the person I1 is positioned. Next, the image-tracking unit 140 drives the rotation motor 180, such that the coordinates (X1, X2) of the image of the person I1 is moved to the coordinates (Xref, Yref) of the reference point of the frame. Thus, the image-capturing unit 110 and the mark T are always aimed at the person.

Next, the method proceeds to step 206, a mark T is catapulted to the invader. In step 203, the person has been identified as the invader, so the user can drive the mark-catapulting unit 130 at a remote end to catapult a mark T to the invader by the remote monitoring unit 160.

Then, the method proceeds to step 207, the remote monitoring unit 150 informs a police station 700. The remote control unit 150 can automatically or manually inform the police station 700 of the information of the image of the invader and the site of offence.

Next, after the police station 700 receives relevant information from the remote monitoring unit 150, the police can take action to arrest the invader.

Despite the monitoring method of the present embodiment of the invention is exemplified by the flowchart of FIG. 2, however, any one who is skilled in the technology of the invention will understand that the monitoring method of the invention is not limited thereto. For example, step 204 is not necessarily performed after step 203, but rather, step 204 can be performed after step 202 immediately and continuously performed with step 202 simultaneously; step 205 is not necessarily performed after step 204, step 205 can be performed after step 203 immediately and continuously performed with step 203 simultaneously. Besides, step 207 is not necessarily performed after step 206, step 207 can be performed after step 203 immediately and continuously performed with step 203 simultaneously.

### Second Embodiment

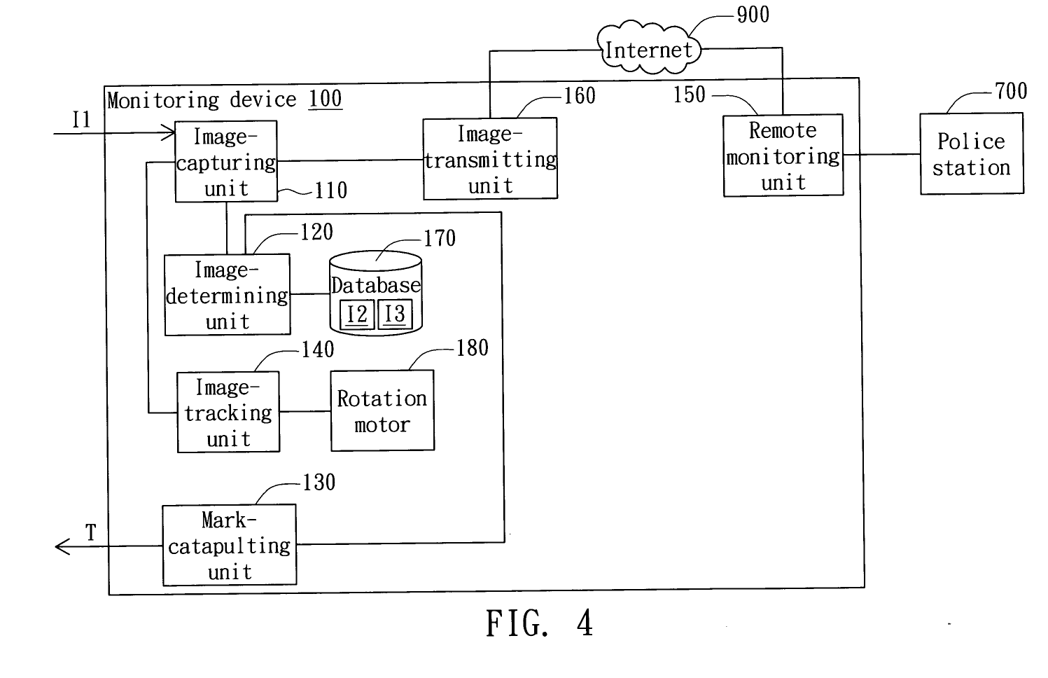

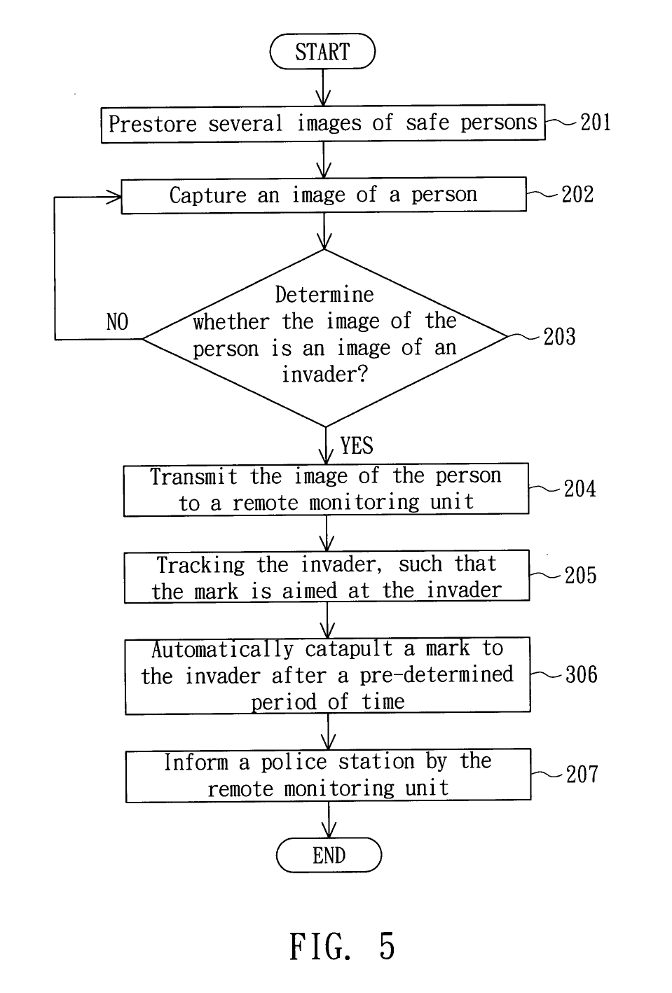

The monitoring device 200 and the monitoring method of the present embodiment of the invention differ from the monitoring device 100 and the monitoring method of the first embodiment in that the mark-catapulting unit 130 automatically catapults a mark T to the invader after the invader is identified, and other similarities are not repeated here. Referring to both FIG. 4 and FIG. 5. FIG. 4 is a functional block diagram of a monitoring device 200 according to a second embodiment of the invention. FIG. 5 is a flowchart of a monitoring method according to a second embodiment of the invention. In step 306 of the present embodiment of the invention, after the image-determining unit 120 has identified the invader for a pre-determined period of time, the mark-catapulting unit 130 automatically catapults a mark T to the invader without having to wait for the command from the remote monitoring unit 150. Thus, when the Internet 900 is unstable or the image-transmitting unit 160 is damaged, the mark-catapulting unit 130 still can function properly.

According to the monitoring device and the monitoring method disclosed in the above embodiments of the invention, a mark is catapulted to a person if the person is identified as an invader, not only achieving the effect of scaring the invader but also leaving an obvious and hard-to-remove mark on the invader. The police and people can easily recognize the invader according to the mark, making crime cracking easier.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A monitoring device, comprising:
an image-capturing unit for capturing an image of a person;
an image-determining unit for determining whether the image of the person is an image of an invader; and
a mark-catapulting unit for catapulting a mark to the invader.

2. The monitoring device according to claim 1, further comprising:
an image-tracking unit for tracking the invader such that the image-capturing unit and the mark are aimed at the invader.

3. The monitoring device according to claim 1, further comprising:
a remote monitoring unit disposed at a remote end; and
an image-transmitting unit for transmitting the image of the person to the remote monitoring unit.

4. The monitoring device according to claim 3, wherein the remote monitoring unit is used for driving the mark-catapulting unit.

5. The monitoring device according to claim 3, wherein the remote monitoring unit is for informing a police station.

6. The monitoring device according to claim 1, wherein the mark is paint, a paint capsule, powder, a powder capsule or a mini signal transmitter.

7. The monitoring device according to claim 1, further comprising:
a database for storing a plurality of safe persons' images, wherein the image-determining unit determines whether the image of the person is different from the images of safe persons by comparison, if so, the person is identified as the invader.

8. The monitoring device according to claim 1, further comprising:
a database for storing a head-covered image, wherein the image-determining unit determines whether the head image of the person has the head-covered image by comparison, if so, the person is identified as the invader.

9. The monitoring device according to claim 1, wherein the mark-catapulting unit automatically catapults the mark after the invader is identified for a pre-determined period of time.

10. The monitoring device according to claim 1, further comprising:
a rotation motor, wherein the image-tracking unit drives the rotation motor such that the image of the person is positioned at a reference point of the frame.

11. A monitoring method, comprising:
capturing an image of a person;
determining whether the image of the person is an image of an invader; and
catapulting a mark to the invader if the person is the invader.

12. The monitoring method according to claim 11, further comprising:
tracking the invader, such that the mark is aimed at the invader.

13. The monitoring method according to claim 11, further comprising:
transmitting the image of the person to a remote monitoring unit.

14. The monitoring method according to claim 13, wherein the step of catapulting the mark is activated by the remote monitoring unit.

15. The monitoring method according to claim 13, further comprising:
informing a police station by the remote monitoring unit.

16. The monitoring method according to claim 11, wherein the mark is paint, a paint capsule, powder, a powder capsule or a mini signal transmitter.

17. The monitoring method according to claim 11, wherein a plurality of safe persons' images are stored before the step of capturing an image, the step of determining an image by comparison comprises:
determining whether the image of the person is different from the images of safe persons by comparison, if so, the person is identified as the invader.

18. The monitoring method according to claim 11, wherein a head-covered image is stored before the step of capturing an image, the step of determining an image by comparison comprises:
determining whether the head image of the person has the head-covered image by comparison, if so, the person is identified as the invader.

19. The monitoring method according to claim 11, wherein after the step of determining an image by comparison, if the person is identified as the invader, the step of catapulting the mark is automatically activated after the invader is identified for a pre-determined period of time.

20. The monitoring method according to claim 11, wherein the step of tracking comprises:
driving a rotation motor, such that the image of the person is positioned at a reference point of the frame.
